(19) United States
(12) Patent Application Publication
(10) Pub. No.: US 2014/0360299 A1
(43) Pub. Date: Dec. 11, 2014

(54) ROTATION SPEED MEASURING DEVICE

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventor: QI-LONG YU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/060,624

(22) Filed: Oct. 23, 2013

(30) Foreign Application Priority Data
Jun. 5, 2013 (CN) 2013102207914

(51) Int. Cl. F16H 1/18

(52) U.S. Cl. CPC F16H 1/18
USPC 74/423; 74/412 R

(57) ABSTRACT

A rotation speed measuring device for measuring a rotation speed of a shaft includes an acceleration sensor, a fits gear, and a second gear. The first gear is fixed to the shaft and rotatable about an axis that the shaft rotates about. The second gear engages with the first gear and is rotatable about a vertical axis. The second gear has a support surface that is perpendicular to the vertical axis. The acceleration sensor is arranged on the support surface and has an acceleration sensing axis that is perpendicular to and coplanar with the vertical axis.

### BACKGROUND

1. Technical Field

The present disclosure relates to a rotation speed measuring device.

2. Description of Related Art

Generally, the rotation speed of rotating equipments such as electric motors is determined by measuring the time required for a single rotation, for example. However, one problem with this approach is that if the rotation speed is slow, a single rotation may take a long time, so that the duration of measurement takes a long time. Thus, there is a need for providing a rotation speed measuring device to solve the aforementioned problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of a rotation speed measuring device connected to a computer, according to one embodiment.

FIG. 2 is a schematic view showing an acceleration sensor and a first gear and a second gear of the rotation speed measuring device that are engaged with each other.

FIG. 3 is an enlarged view of the portion III of FIG. 2.

### DETAILED DESCRIPTION

Embodiments of the present disclosure will be described with reference to the accompanying drawings.

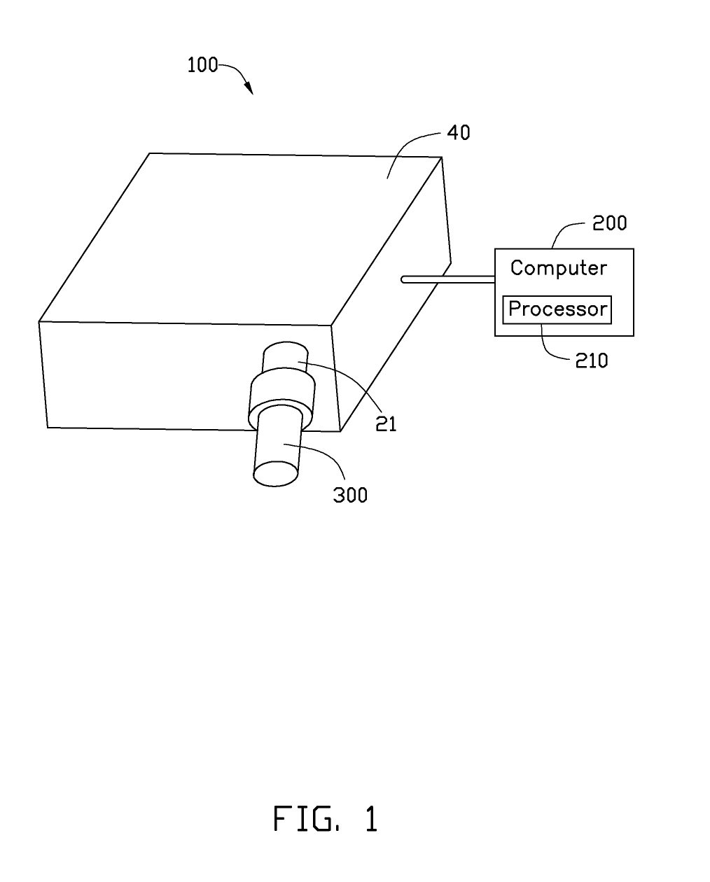

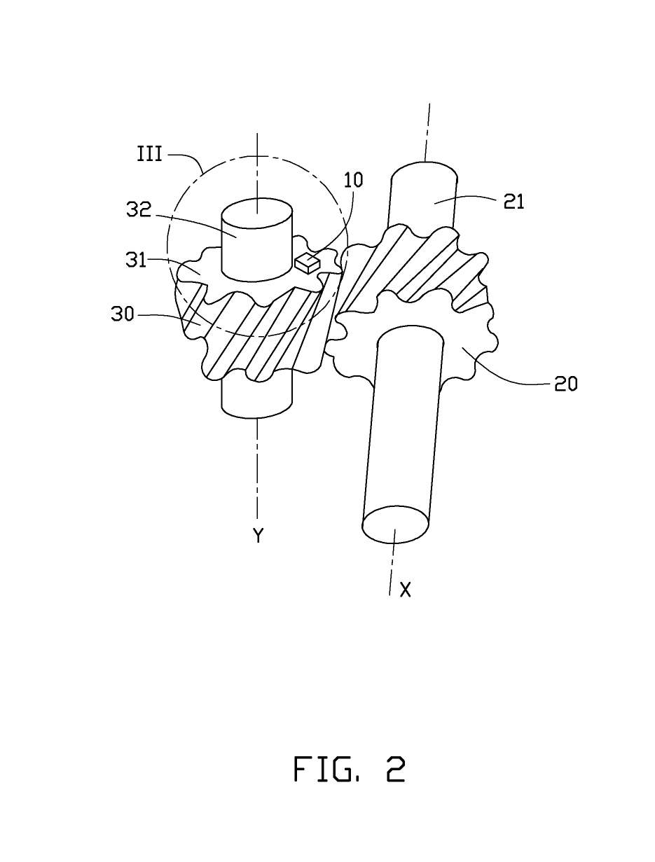

Referring to FIGS. 1-2, a rotation speed measuring device 100 includes an acceleration sensor 10, a first gear 20, and a second gear 30. The first gear 20 and the second gear 30 are accommodated in a casing 40. The acceleration sensor 10 is connected to a processor 210 of a computer 200. The first gear 20 is secured to a shaft 300 and rotates about an axis that the shaft 300 rotates about.

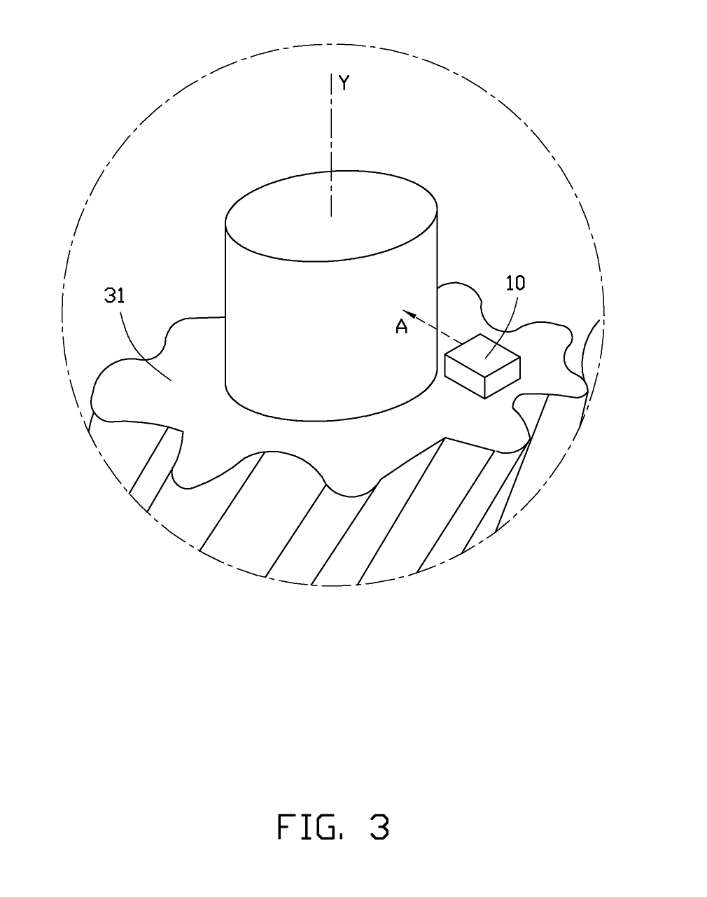

The first gear 20 and the second gear engage with each other. The second gear 30 is rotatable about a vertical axis Y, and includes a support surface 31 that is perpendicular to the vertical axis Y. The acceleration sensor 10 is secured to the support surface 31, and has an acceleration sensing axis A that is perpendicular to and coplanar with the vertical axis Y (see FIG. 3).

In the embodiment, the first gear 20 is rotatably connected to the casing 40 via an axle 21, and the second gear 30 is rotatably connected to the casing 40 via an axle 32. The axle 21 is connected to the shaft 300 via a coupler.

Since the support surface 31 is perpendicular to the vertical axis Y, the acceleration sensing axis A is perpendicular to the direction of gravity. Thus, the acceleration sensor 10 will not be affected by gravity, and the acceleration detected by the acceleration sensing axis A is caused by the rotation of the second gear 30. The processor 210 calculates an acceleration value α based on the output of the acceleration sensor 10. The processor 210 then calculates the velocity V of the acceleration sensor 10 according to the acceleration value α and the distance R between the acceleration sensor 10 and the vertical axis Y. The velocity V equals to the square root of the product of the acceleration value α and the distance R. The rotation speed w of the acceleration sensor 10 is then calculated: ω=V/2πR. Since the acceleration sensor 10 is secured to the second gear 30, the acceleration sensor 10 and the second gear 30 have the same rotation speed.

In the embodiment, the gear ratio of the first gear 20 and the second gear 30 is 1. Thus, the first gear 20 and the second gear 30 have the same rotation speed. The rotation speed of the shaft 300 is then determined to be equal to the rotation speed of the acceleration sensor 10.

In the embodiment, the first gear 20 and the second gear 30 are helical gears, and the acceleration sensor 10 is a single axis accelerometer. In other embodiments, the first gear 20 and the second gear 30 may be bevel gears.

While various embodiments have been described and illustrated, the disclosure is not to be construed as being limited thereto. Various modifications can be made to the embodiments by those skilled in the art without departing from the true spirit and scope of the present disclosure.

What is claimed is:

1. A rotation speed measuring device for measuring a rotation speed of a shaft, the rotation speed measuring device comprising:
an acceleration sensor;
a first gear to be fixed to the shaft and rotatable about an axis about which the shaft rotates; and
a second gear engaged with the first gear and being rotatable about a vertical axis, the second gear comprising a support surface that is perpendicular to the vertical axis;
wherein the acceleration sensor is arranged on the support surface and comprises an acceleration sensing axis that is perpendicular to and coplanar with the vertical axis.

2. The rotation speed measuring device according to claim 1, wherein the first gear and the second gear are helical gears.

3. The rotation speed measuring device according to claim 1, wherein the first gear and the second gear are bevel gears.

4. The rotation speed measuring device according to claim 1, wherein the acceleration sensor is a single axis accelerometer.
